(19) United States
(12) Patent Application Publication
(10) Pub. No.: US 2026/0003572 A1
(43) Pub. Date: Jan. 1, 2026

(54) Design Method for Fixed-Point and Floating-Point Adder

(71) Applicant: Jiangsu Huachuang Microsystem Company Limited, Nanjing (CN)

(72) Inventors: Xin YUE, Nanjing (CN); Kai CHEN, Nanjing (CN); Ziheng TENG, Nanjing (CN); Shiping LI, Nanjing (CN); Guoqiang HE, Nanjing (CN)

(73) Assignee: Jiangsu Huachuang Microsystem Company Limited, Nanjing (CN)

(21) Appl. No.: 19/010,211

(22) Filed: Jan. 6, 2025

(30) Foreign Application Priority Data
Jun. 26, 2024 (CN) 202410832420.X

(51) Int. Cl. G06F 7/485

(52) U.S. Cl. CPC G06F 7/485

(57) ABSTRACT

A design method for a fixed-point and floating-point adder includes: S1, performing fixed-point and floating-point identification by a shared mantissa addition module; S2, for fixed-point numbers, performing low-bit calculation in the shared mantissa addition module; configuring a fixed-point number processing module, saving a carry of a highest bit in low-bit calculation results, and transmitting the saved carry to the fixed-point number processing module to obtain a fixed-point number addition result; S3, for floating-point numbers, performing calculation, in the shared mantissa addition module, on mantissas of the floating-point numbers, configuring a floating-point number processing module, and performing exponent matching and normalization on exponents of the floating-point numbers to obtain a normalized result; obtaining a floating-point number addition result according to sign bits of the floating-point numbers, the exponents subjected to the exponent matching and the normalized result; and S4, transmitting the result to an output module, and outputting the result.

### CROSS REFERENCE TO THE RELATED APPLICATIONS

This application is based upon and claims priority to Chinese Patent Application No. 202410832420.X, filed on Jun. 26, 2024, the entire contents of which are incorporated herein by reference.

### TECHNICAL FIELD

The invention relates to the technical field of neural network processing elements, in particular to a design method for a fixed-point and floating-point adder.

### BACKGROUND

With the rapid development of artificial intelligence (AI), AI training and reasoning, as a calculation-intensive task, require a powerful high-performance calculation scheme. A neural network processing unit (NPU), as a dedicated design for neural network computation to process complex algorithms and mass data, is widely used to accelerate AI tasks, particularly deep learning algorithms and machine learning algorithms. In neural network training and reasoning computation, there is a diversity of accuracy requirements for data, and the floating-point and fixed-point calculation capacity is of great importance for the NPU. Adders are core calculation units of the NPU, and the performance of the adders has a direct influence on the processing capacity of the NPU. According to the formats of data processed by adders, the adders are classified into floating-point adders and fixed-point adders. A fixed-point number includes a fixed-point integer and a fixed-point decimal. Because the position of a decimal point of the fixed-point number is fixed, the range of data that can be represented by the fixed-point number is limited; and mantissa alignment is not needed in the calculation process of the fixed-point number, so calculation is simple. A floating-point number is formed by an exponent and a mantissa, and compared with the fixed-point number, the dynamic range of data represented by the floating-point number is broader, and the data accuracy is higher, leading to a larger circuit scale and higher logic resource consumption.

Classic neural networks include the convolutional neural network and the recurrent neural network, and are typically formed by a convolutional layer, an activation function layer, a pooling layer, a fully connected layer, a softmax layer, etc. When the neural network performs calculation by means of adders, fixed-point number calculation is needed sometimes while floating-point number calculation is needed sometimes. For example, fixed-point number calculation is preferred for the convolutional layer that is generally located at the front of the neural network due to the limitation of the memory and bandwidth; floating-point number calculation is preferred for the activation function layer that involves some nonlinear operations, to achieve higher accuracy; and floating-point number computation is also preferred for the fully connected layer with a high calculation intensity to guarantee the accuracy to some extent.

However, existing adders applied to the neural networks still have the following problems: (1) the adders cannot process fixed-point data and floating-point data at the same time, and format conversion is needed, so these adders cannot directly satisfy application requirements of the neural networks; (2) adder modules required by the neural networks have a large area, leading to higher power consumption; (3) the adders have an excessively large delay in operation, for example, serial carry adders have an excessively large gate circuit delay, and carry look-ahead adders also have higher power consumption and a larger delay in a case of more times of recursion; and a shift unit in the adders will not perform a shift operation unit a calculation result is obtained, thus leading to a large delay.

### SUMMARY

The technical issue to be settled by the invention is how to design a fixed-point and floating-point adder which can implement both fixed-point number calculation and floating-point number calculation required by neural networks and can effectively reduce the delay and power consumption.

To settle the above technical issue, the invention provides a design method for a fixed-point and floating-point adder; which is implemented by the following technical solution:

A design method for a fixed-point and floating-point adder, including the following steps:
S1, configuring a shared mantissa addition module at an input terminal of a fixed-point and floating-point adder, receiving input data from the input terminal by the shared mantissa addition module, and performing fixed-point and floating-point identification on the input data to determine a data type of the input data, wherein the data type includes fixed-point numbers and floating-point numbers, each of the fixed-point numbers includes a sign bit and numerical bits, and each of the floating-point numbers includes a sign bit, an exponent and a mantissa;
S2, in a case where the input data are the fixed-point numbers, performing, in the shared mantissa addition module configured in S1, low-bit calculation on the numerical bits of the fixed-point numbers to obtain low-bit calculation results; configuring a fixed-point number processing module, saving a carry of a highest bit in the low-bit calculation results, transmitting the saved carry to the fixed-point number processing module, and obtaining a fixed-point number addition result according to the sign bits of the fixed-point numbers and the saved carry;
S3, in a case where the input data are the floating-point numbers, performing calculation, in the shared mantissa addition module configured in S1, on the mantissas of the floating-point numbers to obtain a floating-point mantissa addition result; configuring a floating-point number processing module, and performing exponent matching on the exponents of the floating-point numbers; configuring a pre-shift unit in the floating-point number processing module, and performing normalization on the floating-point mantissa addition result by the pre-shift unit to obtain a normalized result; obtaining a floating-point number addition result according to the sign bits of the floating-point numbers, the exponents subjected to the exponent matching and the normalized result; and
S4, transmitting the fixed-point number addition result obtained in S2 or the floating-point number addition result obtained in S3 to an output module, and outputting the fixed-point number addition result or the floating-point number addition result by an output terminal of the fixed-point and floating-point adder.

The shared mantissa addition module is used to preliminarily process floating-point numbers and fixed-point numbers at the same time to complete mantissa addition of the floating-point numbers and low-bit calculation of the fixed-point numbers, and the mantissa addition module can be shared and reused, such that logic resources required by the adder are reduced, the area and power consumption of the adder are reduced, and the adder can process both fixed-point numbers and floating-point numbers, thus satisfying the application requirements of neural network; in addition, the pre-shift unit is arranged in the floating-point number processing module to perform normalization, thus further increasing the calculation speed and reducing the delay.

Preferably, in S1, the shared mantissa addition module includes multiple groups of carry look-ahead adders, and the multiple groups of carry look-ahead adders are sequentially connected in a manner of serial carry. By connecting multiple groups of carry look-ahead adders in series, the power consumption and area are reduced.

Preferably, each group of carry look-ahead adders is formed by multiple 1 bit full adders in a manner of intra-group carry look-ahead. Multiple 1 bit full adders perform intra-group carry look-ahead, such that the calculation speed is increased, and the delay is reduced.

Preferably, in S3, when the normalization is performed, if the floating-point mantissa addition result is an unnormalized number, left normalization is performed; and if the floating-point mantissa addition result overflows, right normalization is performed. Normalization is performed to guarantee the effective accuracy of data and reduce calculation errors.

Preferably, in S3, after the normalization is performed on the floating-point mantissa addition result, the floating-point mantissa addition result is rounded to nearest according to an IEEE-754 standard. Because the accuracy of floating-point number representation in the fixed-point and floating-point adder is limited and the accuracy of floating-point number representation in a device that receives outputs from the fixed-point and floating-point adder is also limited, the floating-point number calculation result must be rounded. By adopting rounding to nearest, the calculation result can be rounded to a nearest value that can be represented, to be approximate to an actual mathematic result, thus reducing rounding errors.

Preferably, in S3, after the normalized result is obtained, floating-point number overflow processing is performed on the normalized result; the floating-point number overflow processing includes positive overflow processing and negative overflow processing; and a maximum positive normalized number is taken as a positive overflow processing result, and a minimum negative normalized number is taken as a negative overflow processing result. A floating-point number overflow indicates that the calculation result exceeds an actual representation range and will destroy the stability and accuracy of calculation, so overflow processing should be performed to guarantee the accuracy of calculation.

Preferably, in S3, a parallel logic is adopted between the pre-shift unit and the shared mantissa addition module. The pre-shift unit can parallelly determine in advance how to perform normalization later without wait for the end of calculation of the shared mantissa addition module, such that the calculation delay is effectively reduced.

Preferably, operands are included in the mantissas of the floating-point numbers; and when the normalization is performed in S3, the pre-shift unit calculates the number of leading 0/1 according to the operands, and the number of places to be shifted to the left during the normalization is determined in advance according to the number of leading 0/1. Leading 0/1 refers to the value of a highest bit of a normalized mantissa, and the pre-shift unit can determine the number of leading 0/1 quickly according to operands to make determination in advance, such that the calculation speed is increased.

Preferably, in S3, when the normalization is performed by the pre-shift unit, the pre-shift unit adopts a carry generation function, a carry propagation function and an annihilation function. By means of the three functions, an operation to be performed by the pre-shift unit for normalization can be figured out quickly, such that the calculation efficiency is improved, and the calculation delay is reduced.

Compared with the prior art, the invention has the following beneficial effects:

The fixed-point and floating-point adder adopted by the invention can implement both fixed-point number calculation and floating-point number calculation, and compared with existing adders that can only implement fixed-point number calculation or floating-point number calculation, the scheme provided by the invention has better performance and can better satisfy complex application requirements of neural networks; moreover, the shared mantissa addition module is reused, such that the area of the adder is reduced, and power consumption is greatly reduced; in addition, the pre-shift unit is used to make a determination for normalization in advance, and normalization can be performed without waiting for the completion of mantissa calculation, such that the delay is effectively reduced, and the calculation speed is increased.

### BRIEF DESCRIPTION OF THE DRAWINGS

FIG. 1 is a schematic diagram of a fixed-point and floating-point adder;

FIG. 2 is a schematic structural diagram of a group of 4 bit carry look-ahead adders;

FIG. 3 is a connection diagram of multiple groups of 4 bit carry look-ahead adders;

FIG. 4 is a schematic operating diagram of a pre-shift unit.

### DETAILED DESCRIPTION OF THE EMBODIMENTS

The technical solutions in some embodiments of the invention are described in detail below in conjunction with drawings of these embodiments.

### Embodiment

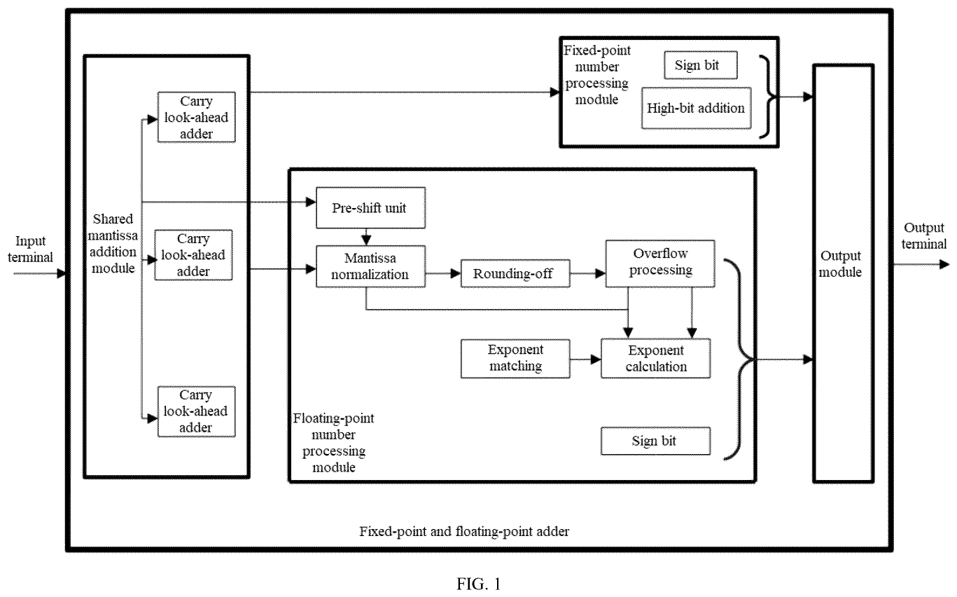

As shown in FIG. 1 which is a schematic diagram of a fixed-point and floating-point adder, the fixed-point and floating-point adder is suitable for both fixed-point data and floating-point data, processes fixed-point numbers and floating-point numbers synchronously by means of a shared mantissa addition module, and then transmits respective processing results to corresponding processing modules to complete addition finally.

A design method for a fixed-point and floating-point adder specifically includes the following steps:

S1, a shared mantissa addition module is configured at an input terminal of a fixed-point and floating-point adder, wherein the shared mantissa addition module includes multiple groups of carry look-ahead adders. The specific number of the carry look-ahead adders should be set according to data actually to be processed. For example, if 20 bit data need to be processed, five groups of 4 bit carry look-ahead adders will be used. For another example, if 16 bit data need to be processed, 4 groups of 4 bit carry look-ahead adders will be used. The shared mantissa addition module receives input data from the input terminal, and the input data may include fixed-point numbers or floating-point numbers, wherein each fixed-point number includes a sign bit and numerical bits, and each floating-point number includes a sign bit, an exponent and a mantissa, the exponent may also be referred to as an exponent bit, and the mantissa may also be referred to as a mantissa bit; and fixed-point and floating-point identification may be performed according to different information in the two types of data to determine whether the input data are fixed-point numbers or floating-point numbers.

It should be noted that an addition process of the carry look-ahead adders adopted in this embodiment is modified by deep reasoning of the operation logic of traditional carry look-ahead adders. With a traditional carry look-ahead adder, the bit width of input operands of which is N, as an example, if input operands are set as Xₙ and Yₙ, n∈[N, 1], a carry generation function is expressed as (1-1):Gₙ₋₁=Xₙ₋₁*Yₙ₋₁, n∈[N, 1], where * denotes a multiply operation; a carry propagation function is expressed as (1-2):Pₙ₋₁=Xₙ₋₁⊕Yₙ₋₁, n∈[N, 1], where ⊕ denotes an XOR operation; a carry from a lower bit and a carry of a highest bit are

$$\{ \begin{matrix}{C}_{in} = {C}_{0} \\ {C}_{out} = {C}_{N}\end{matrix} ;$$

expressed as (1-3): a carry look-ahead flag is denoted as (1-4):Cₙ=Gₙ₋₁+Pₙ₋₁*Cₙ₋₁, n∈[N, 1]; and an output result of the carry look-ahead adders is (1-5): Sₙ₋₁=Xₙ₋₁⊕Yₙ₋₁⊕Cₙ₋₁. With a gradual increase of the bit width of such traditional carry look-ahead adders, the circuit complexity will be increased correspondingly, the area is large, and power consumption is high. In view of this, the carry look-ahead adders adopted in this embodiment are improved.

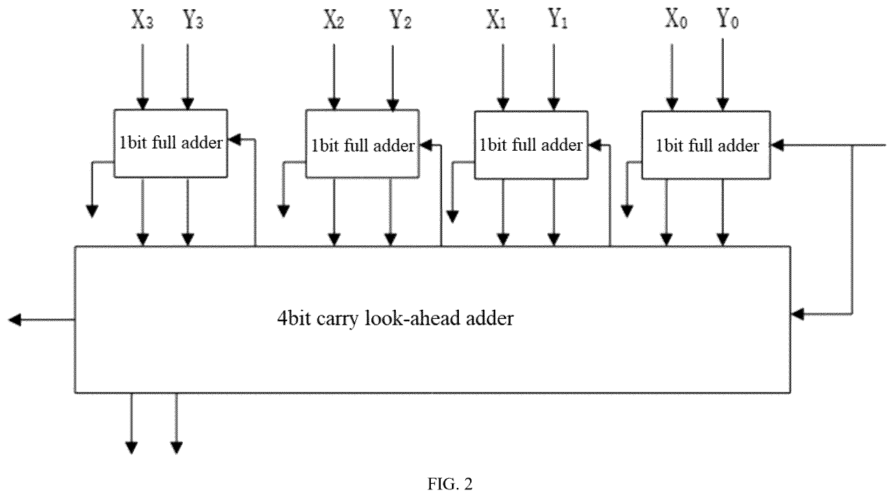

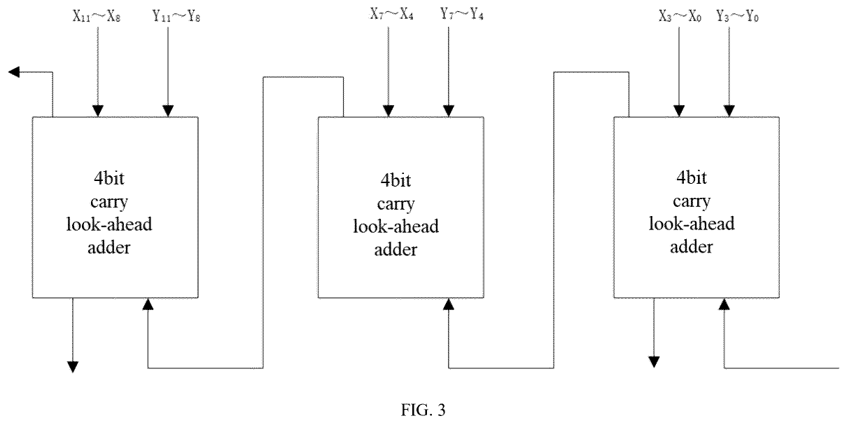

Referring to FIG. 2 which is a schematic structural diagram of a group of 4 bit carry look-ahead adders and FIG. 3 which is a connection diagram of multiple groups of 4 bit carry look-ahead adders, for example, in a case where 16 bit fixed-point numbers or 16 bit floating-point numbers are processed, because the mantissa of the 16 bit floating-point number includes 10 bits, a hidden bit of the 16 bit floating-point number include one bit and the sign bit of the 16 bit floating-point number includes one bit, the shared mantissa addition module need to process 12 bits. In this embodiment, an “intra-group carry look-ahead and inter-group serial carry” addition module is designed for three groups of carry look-ahead adders in the shared mantissa addition module, that is, multiple 1 bit full adders in each group are connected in parallel and adopt carry look-ahead to ensure the calculation speed in the group; and different groups are connected in series to guarantee the sequence of calculation. The three groups of carry look-ahead adders cover 12 low bits of the 16 bit fixed-point number (each group covers 4 bits), and a 4 bit carry look-ahead design is adopted in each group. Wherein, C denotes a carry, P denotes a “forward propagation” signal, G is a “generation” signal related to P, S denotes summation, and X and Y denotes operands.

The carry of each bit of any one group of 4 bit carry look-ahead adders can be obtained by (1-4) and may be expressed as:

$$\{ \begin{matrix}{C}_{1} = {G}_{0} + {P}_{0} {C}_{0} \\ {C}_{2} = {G}_{1} + {P}_{1} {G}_{0} + {P}_{1} {P}_{0} {C}_{0} \\ {C}_{3} = {G}_{2} + {P}_{2} {G}_{1} + {P}_{2} {P}_{1} {G}_{0} + {P}_{2} {P}_{1} {P}_{0} {C}_{0} \\ {C}_{4} = {G}_{3} + {P}_{3} {G}_{2} + {P}_{3} {P}_{2} {G}_{1} + {P}_{3} {P}_{2} {P}_{1} {G}_{0} + {P}_{3} {P}_{2} {P}_{1} {P}_{0} {C}_{0}\end{matrix} \qquad ( 1 - 6 )$$

a calculation result of any one group of 4 bit carry look-ahead adders can be obtained by substituting (1-6) into (1-5):

$${S}_{3 : 0} = {X}_{3 : 0} ⊕ {Y}_{3 : 0} ⊕ {C}_{3 : 0} \qquad ( 1 - 7 )$$

It can be known from (1-7) that the calculation result of any one group of carry look-ahead adders is only related to the input operands and the carry and is unrelated to low-bit calculation results. Hence, when the shared mantissa addition module performs low-bit calculation on the fixed-point numbers, only a carry of a highest bit in the low-bit calculation results needs to be saved and transmitted, and this will not lead to a mistake of a final result of the fixed-point numbers. The shared mantissa addition module can also perform calculation on mantissas of floating-point numbers. The same module is reused for processing numbers in two formats, such that the area and power consumption of the adders are reduced under the condition that the accuracy is guaranteed; and after calculation is completed by the shared mantissa addition module, the fixed-point numbers or the floating-point numbers will be transmitted to a corresponding subsequent module to be processed, thus effectively reducing the delay.

The carry and calculation result of each of the three groups of 4 bit carry look-ahead adders adopted in this embodiment follow (1-6) and (1-7). A delay from C₀ to C₄ of the first group of 4 bit carry look-ahead adders is a four-stage gate circuit; a delay from C₄ to C₈ of the second group of 4 bit carry look-ahead adders is a two-stage gate circuit, six stages in total together with the delay from C₀ to C₄; a delay from C₈ to C₁₂ of the third group of 4 bit carry look-ahead adders is a two-stage gate circuit, eight stages in total together with the delay from C₀ to C_{8.} Therefore, the delay of the 12 bit “intra-group carry look-ahead and inter-group serial carry” addition module is an eight-stage gate circuit.

S2, if the input data are fixed-point numbers, low-bit calculations is performed in the shared mantissa addition module on the numerical bits of the fixed-point numbers to obtain low-bit calculation results. Then, a fixed-point number processing module is configured; for an add operation of the fixed-point numbers, after the input data are processed by the shared mantissa addition module to obtain the low-bit calculation results, a carry of a highest bit in the low-bit calculation results is saved and transmitted to the fixed-point number processing module to perform high-bit addition, and a high-bit addition module receives the carry from the lower bit and obtains a final fixed-point number addition result according to the corresponding sign bits.

The fixed-point numbers are fixed-point integers or fixed-point decimals according to their numerical bits. For fixed-point decimals, the mantissa of the fixed-point numbers is a value part behind a decimal point, the position of the decimal point is fixed and known, so mantissa processing is not needed, addition can be performed directly and simply, and extra calculation is not needed; in addition, the fixed-point numbers can be divided into low bits and high bits, wherein the low bits include a major proportion of the numerical bits, so after the shared mantissa addition module completes low-bit calculation, subsequent high-bit calculation can also be completed quickly.

S3, if the input data are floating-point numbers, calculation is performed on the mantissas of the floating-point numbers in the shared mantissa addition module to obtain a floating-point mantissa addition result. The shared mantissa addition module is used, such that logic resources required by the fixed-point and floating-point adder are reduced, and the area and power consumption are reduced. Then, a floating-point number processing module is configured, and exponent matching is performed on the exponents of the floating-point numbers. Because the exponents of different floating-point numbers may be different drastically, a serious numerical underflow or overflow may be caused if addition is performed directly. In view of this, exponent matching is performed to ensure that calculation is performed under the same magnitude so as to guarantee the validity of calculation.

It should be noted that the floating-point number is formed by a sign bit, an exponent and a mantissa. In floating-point number representation, the position of the decimal point is unknown and unfixed and needs to be determined according to the exponent. During addition of the floating-point numbers, the decimal points of the floating-point numbers should be aligned to ensure that mantissa calculation can be performed correctly.

In floating-point number representation, the mantissa is a part behind the decimal point and generally needs to be normalized. During addition of two or even more floating-point numbers, a result beyond a normalized range may be obtained by adding the mantissas. For example, if a result obtained by adding two mantissas is 2.101, this result needs to be normalized into a range between 1 and 2, that is, the result needs to be shifted to the right by one place to obtain 1.1010, and this process is implemented by a shift unit or a pre-shift unit. In the process of shifting the result to the right, “leading 0/1” refers to the value of a highest bit of the normalized result. If the value of the highest bit is 0, it indicates that the result can be further shifted to the right, that is, the decimal point can be shifted to the left until the value of the highest bit is 1, and the number of places by which the result is shifted to the right at this moment is the number of places to be shifted to the left.

In addition, when the mantissa addition result is normalized, if the mantissa addition result overflows, right normalization is needed, that is, the mantissa addition result needs to be shifted to the right by one place; and if the mantissa addition result is a unnormalized number, right normalization is needed. A floating-point number overflow indicates that the calculation result exceeds an actual representation range and will destroy the stability and accuracy of calculation, so overflow processing should be performed to guarantee the accuracy of calculation. Wherein, the pre-shift unit is designed for left normalization, and the number of leading 0/1 is calculated directly according to input operands to determine in advance the number of places to be shifted without waiting for the completion of mantissa addition. Then, the normalized calculation result is rounded, and, a rounding method adopted in this embodiment is rounding to nearest in the IEEE-754 standard.

Then, floating-point overflow processing is performed according to the rounded mantissa addition result and the exponents. A floating-point overflow processing method adopted in this embodiment is that a positive overflow processing result is a maximum positive normalized number that can be represented in a floating-point number format, and a negative overflow processing result is a minimum negative normalized number that can be represented in the floating-point number format. Because the accuracy of floating-point number representation in the fixed-point and floating-point adder is limited and the accuracy of floating-point number representation in a device that receives outputs from the fixed-point and floating-point adder is also limited, the floating-point number calculation result must be rounded. By adopting rounding to nearest, the calculation result can be rounded to a nearest value that can be represented, to be approximate to an actual mathematic result, thus reducing rounding errors.

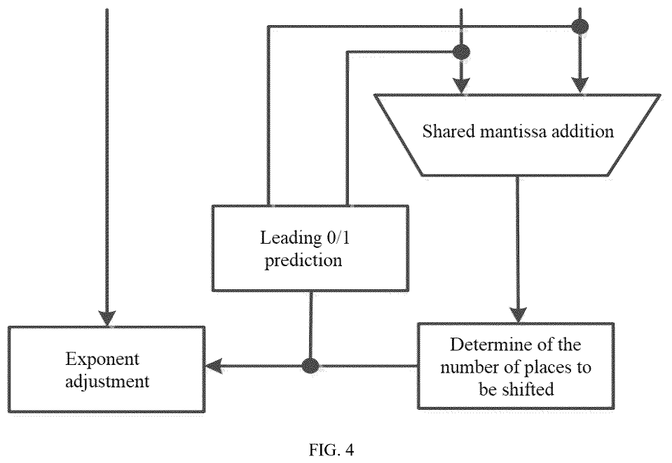

As shown in FIG. 4 which is a schematic operating diagram of the pre-shift unit adopted in the invention, the pre-shift unit is configured in the floating-point number processing module and is connected in parallel to the shared mantissa addition module by modifying a traditional serial logic into a parallel logic. The pre-shift unit directly predicts the number of leading 0/1 according to operands in the input data without waiting for the completion of mantissa addition, to determine the number of places to be shifted to the left so as to make preparation for normalization.

In the pre-shift unit, three functions are used to predict the number of leading 0/1, wherein a carry generation function is (1-1), a carry propagation function is (1-2), and an annihilation function is expressed by the following formula:

$${A}_{n} = \overline{{X}_{n} + {Y}_{n}} ( not operation of {X}_{n} + {Y}_{n} ) \qquad ( 1 - 8 )$$

The pre-shift unit, when operating, calculates the number of leading 0 and the number of leading 1, and assume a first 0 in the carry propagation function appears at an n^{th} bit, the number of places to be shifted to the left may be obtained by the following formula:

$$\{ \begin{matrix}{P}_{0} = {P}_{- 1} = {P}_{- 2} = {P}_{- 3} = … … = {P}_{- n + 1} = 1 \neq {P}_{- n} \\ {P}_{- n} = 0\end{matrix} \qquad ( 1 - 9 )$$

(1) Calculation of leading 0

if G₋ₙ=0, m=n; if G₋ₙ=1, the value of m may be obtained by the following formula:

$$\{ \begin{matrix}{G}_{- n} = {A}_{- n - 1} = {A}_{- n - 2} = {A}_{- n - 3} = … … = {A}_{- m + 1} = 1 \neq {A}_{- m} \\ {A}_{- m} = 0\end{matrix} \qquad ( 1 - 10 )$$

wherein, n, m∈[N, 1].

Whether the number of leading 0 is m or m−1 depends on whether the carry of an m^{th} bit is 0 or 1; if Cₘ is 0, the number of leading 0 is m; otherwise, the number of leading 0 is m−1.

(2) Calculation of leading 1

if A₋ₙ=0, m=n; if A₋ₙ=1, the value of m may be obtained by the following formula:

$$\{ \begin{matrix}{A}_{- n} = {G}_{- n - 1} = {G}_{- n - 2} = {G}_{- n - 3} = … … = {G}_{- m + 1} = 1 \neq {G}_{- m} \\ {G}_{- m} = 0\end{matrix} \qquad ( 1 - 11 )$$

wherein, n, m∈[N, 1].

Whether the number of leading 1 is m−1 or m depends on whether the carry of the m^{th} bit is 0 or 1; if Cₘ is 0, the number of leading 1 is m−1; otherwise, the number of leading 1 is m.

According to the number of leading 0/1 predicted by the pre-shift unit, the exponents of the floating-point numbers are further adjusted after exponent matching is performed on the exponents the floating-point numbers. In addition, the floating-point mantissa addition result is rounded to nearest; and after the floating-point mantissa addition result is normalized, a floating-point number addition result is obtained according to the sign bits of the floating numbers, the exponents subjected to the exponent matching, and the normalized result.

S4, if the input data are the fixed-point numbers, the fixed-point number addition result is transmitted to an output module and output by an output terminal of the fixed-point and floating-point adder; or, if the input data are the floating-point numbers, the floating-point number addition result is transmitted to the output module and then output by the output terminal of the fixed-point and floating-point adder.

In addition, under the condition of satisfying actual delay requirements, CRC may be performed by the output module to check whether the calculation result is correct so as to further guarantee the calculation accuracy of the fixed-point and floating-point adder.

### Specific Application Example

A low-delay 16 bit fixed-point and floating-point adder includes a shared mantissa addition module, a fixed-point number processing module and a floating-point number processing module and can process both 16 bit floating-point numbers and 16 bit fixed-point numbers, wherein the floating-point numbers are in conformity with the IEEE-754 standard, and the mantissa of the floating-point numbers occupies 12 bits. The fixed-point and floating-point adder adopts a set of hardware logic calculation resources (the shared mantissa addition module). The shared mantissa addition module is formed by three groups of 4 bit carry look-ahead adders which are connected in series, and each group of 4 bit carry look-ahead adders is formed by four 1 bit full adders which are connected in parallel.

The shared mantissa addition module receives input data from an input terminal of the fixed-point and floating-point adder, and it is determined, by fixed-point and floating-point identification performed according to a control logic adopted by the input data, that the input data are floating-point numbers. Each floating number includes a sign bit, an exponent and a mantissa, wherein the exponent and the mantissa are collectively referred to as a numerical bit of the floating-point number, and the numerical bits of the floating-point numbers include corresponding operands X₀-X₁₁ and operands Y₀-Y₁₁.

Each group of carry look-ahead adders includes four 1 bit full adders which are connected in parallel, and when the four 1 bit full adders are connected, C denotes a carry, P denotes a “forward propagation” signal, G is a “generation” signal related to P, S denotes summation, and X and Y denotes operands; then, carry look-ahead is performed according to (1-4): Cₙ=Gₙ₋₁+Pₙ₋₁*Cₙ₋₁, n∈[N,1]; next, (1-6)

$$\{ \begin{matrix}{C}_{1} = {G}_{0} + {P}_{0} {C}_{0} \\ {C}_{2} = {G}_{1} + {P}_{1} {G}_{0} + {P}_{1} {P}_{0} {C}_{0} \\ {C}_{3} = {G}_{2} + {P}_{2} {G}_{1} + {P}_{2} {P}_{1} {G}_{0} + {P}_{2} {P}_{1} {P}_{0} {C}_{0} \\ {C}_{4} = {G}_{3} + {P}_{3} {G}_{2} + {P}_{3} {P}_{2} {G}_{1} + {P}_{3} {P}_{2} {P}_{1} {G}_{0} + {P}_{3} {P}_{2} {P}_{1} {P}_{0} {C}_{0}\end{matrix}$$

are substituted into (1-5):Sₙ₋₁=Xₙ₋₁⊕Yₙ₋₁⊕Cₙ₋₁to obtain a calculation result (1-7):S_{3.0}−X_{3.0}⊕Y_{3.0}⊕C_{3.0} of each group of carry look-ahead adders.

The three groups of carry look-ahead adders are sequentially connected in series, and a delay from C₀ to C₄ of the first group of 4 bit carry look-ahead adders is a four-stage gate circuit; a delay from C₄ to C₈ of the second group of 4 bit carry look-ahead adders is a two-stage gate circuit, six stages in total together with the delay from C₀ to C₄; a delay from C₈ to C₁₂ of the third group of 4 bit carry look-ahead adders is a two-stage gate circuit, eight stages in total together with the delay from C₀ to C₈. Therefore, the delay of a 12 bit “intra-group carry look-ahead and inter-group serial carry” addition module is an eight-stage gate circuit.

Mantissa addition of the floating-point numbers is completed according to the above calculation process to obtain a floating-point mantissa addition result, and the floating-point mantissa addition result is transmitted to the floating-point number processing module.

A pre-shift unit is configured in the floating-point number processing module and connected in parallel to the shared mantissa addition module, and when left normalization is needed in the floating-point mantissa calculation process performed by the shared mantissa addition module, the pre-shift unit is used to directly predict the number of leading 0/1. In the prediction process, three functions are used, wherein a carry generation function is (1-1):Gₙ₋₁=Xₙ₋₁*Yₙ₋₁, n∈[N, 1]; a carry propagation function is (1-2):Pₙ₋₁=Xₙ₋₁⊕Yₙ₋₁, n∈[N, 1]; and an annihilation function is (1-8): Aₙ=X̅ₙ̅+̅Y̅ₙ̅.

When predicting the number of places to be shifted to the left, the pre-shift unit needs to calculate the number of leading 0 and the number of leading 1; assume a first 0 in the carry propagation function appears at an n^{th} bit, the number of places to be shifted to the left is obtained by the following formula:

$$\{ \begin{matrix}{P}_{0} = {P}_{- 1} = {P}_{- 2} = {P}_{- 3} = … … = {P}_{- n + 1} = 1 \neq {P}_{- n} \\ {P}_{- n} = 0\end{matrix} \qquad ( 1 - 9 )$$

(1) Calculation of leading 0

if G₋ₙ=0, m=n; if G₋ₙ=1, the value of m is obtained by the following formula:

$$\{ \begin{matrix}{G}_{- n} = {A}_{- n - 1} = {A}_{- n - 2} = {A}_{- n - 3} = … … = {A}_{- m + 1} = 1 \neq {A}_{- m} \\ {A}_{- m} = 0\end{matrix} \qquad ( 1 - 10 )$$

wherein, n, m∈[N, 1].

Whether the number of leading 0 is m or m−1 depends on whether the carry of an m^{th} bit is 0 or 1; if Cₘ is 0, the number of leading 0 is m; otherwise, the number of leading 0 is m−1.

(2) Calculation of leading 1

if A₋ₙ=0, m=n; if A₋ₙ=1, the value of m is obtained by the following formula:

$$\{ \begin{matrix}{A}_{- n} = {G}_{- n - 1} = {G}_{- n - 2} = {G}_{- n - 3} = … … = {G}_{- m + 1} = 1 \neq {G}_{- m} \\ {G}_{- m} = 0\end{matrix} \qquad ( 1 - 11 )$$

wherein, n, m∈[N, 1].

Whether the number of leading 1 is m−1 or m depends on whether the carry of the m^{th} bit is 0 or 1; if Cₘ is 0, the number of leading 1 is m−1; otherwise, the number of leading 1 is m.

After left normalization, the calculation result subjected to the left normalization is rounded (rounded to nearest) according to the IEEE-754 standard. If there is still a floating-point number overflow after rounding, positive overflow processing needs to be performed, and a maximum positive normalized number is taken as a positive overflow processing result. At the same time, exponent matching is performed on the exponents of the floating-point numbers, and exponent addition or subtraction is performed, and a floating-point number addition result is obtained according to an exponent addition or subtraction result, the sign bits of the floating-point numbers and the positive overflow processing result and is input to an output module.

The floating-point number addition result is received by the output module and output by an output terminal of the fixed-point and floating-point adder.

Then, the fixed-point and floating-point adder receives input data again and determines, by fixed-point and floating-point identification performed according to a control logic adopted by the input data, that the input data are fixed-point numbers. Each fixed-point number includes a sign bit and numerical bits, wherein the numerical bits include operands X₀-X₁₁ and Y₀-Y₁₁.

The shared mantissa addition module performs calculation on 12 low bits of the fixed-point numbers by means of three groups of carry look-ahead adders, and the calculation process is the same as the mantissa addition process of the floating-point numbers; then, a highest bit in the calculation results is reserved and transmitted to the fixed-point number processing module. In the fixed-point number processing modules, the four remaining high bits of the fixed-point numbers are added, and a fixed-point number addition result is obtained according to a high-bit addition result and the sign bits of the fixed-point numbers and is input to the output module.

The fixed-point number addition result is received by the output module and output by the output terminal of the fixed-point and floating-point adder.

The fixed-point and floating-point adder receives input data again and performs calculation as described above until all data are received and processed.

To sum up, the fixed-point and floating-point adder adopted in the invention can implement both fixed-point number calculation and floating-point number calculation, thus satisfying complex application requirements of neural networks; moreover, the shared mantissa addition module is used, such that the area of the adder is reduced, and power consumption is greatly reduced; in addition, the pre-shift unit is used to make a determination for normalization in advance, and normalization can be performed without waiting for the completion of mantissa calculation, such that the delay is effectively reduced, the calculation speed is increased, and a remarkable improvement is achieved.

The above embodiments are merely used for explaining the technical concept of the invention and are not intended to limit the protection scope of the invention. Any modifications made based on the technical concept of the invention should also fall within the protection scope of the invention.

What is claimed is:

1. A design method for a fixed-point and floating-point adder, comprising the following steps:
S1, configuring a shared mantissa addition module at an input terminal of the fixed-point and floating-point adder, receiving input data from the input terminal by the shared mantissa addition module, and performing fixed-point and floating-point identification on the input data to determine a data type of the input data, wherein the data type comprises fixed-point numbers and floating-point numbers, each of the fixed-point numbers comprises a sign bit and numerical bits, and each of the floating-point numbers comprises a sign bit, an exponent and a mantissa;
S2, when the input data are the fixed-point numbers, performing, in the shared mantissa addition module configured in S1, low-bit calculation on the numerical bits of the fixed-point numbers to obtain low-bit calculation results; configuring a fixed-point number processing module, saving a carry of a highest bit in the low-bit calculation results, transmitting the carry to the fixed-point number processing module, and obtaining a fixed-point number addition result according to the sign bits of the fixed-point numbers and the carry;
S3, when the input data are the floating-point numbers, performing calculation, in the shared mantissa addition module configured in S1, on the mantissas of the floating-point numbers to obtain a floating-point mantissa addition result; configuring a floating-point number processing module, and performing exponent matching on the exponents of the floating-point numbers; configuring a pre-shift unit in the floating-point number processing module, and performing normalization on the floating-point mantissa addition result by the pre-shift unit to obtain a normalized result; obtaining a floating-point number addition result according to the sign bits of the floating-point numbers, the exponents subjected to the exponent matching and the normalized result; and
S4, transmitting the fixed-point number addition result obtained in S2 or the floating-point number addition result obtained in S3 to an output module, and outputting the fixed-point number addition result or the floating-point number addition result by an output terminal of the fixed-point and floating-point adder.

2. The design method for the fixed-point and floating-point adder according to claim 1, wherein in S1, the shared mantissa addition module comprises a plurality of groups of carry look-ahead adders, and the plurality of groups of carry look-ahead adders are sequentially connected in a manner of serial carry.

3. The design method for the fixed-point and floating-point adder according to claim 2, wherein each group of carry look-ahead adders in the plurality of groups of carry look-ahead adders is formed by a plurality of 1bit full adders in a manner of intra-group carry look-ahead.

4. The design method for the fixed-point and floating-point adder according to claim 1, wherein in S3, when the normalization is performed, if the floating-point mantissa addition result is an unnormalized number, left normalization is performed; and if the floating-point mantissa addition result overflows, right normalization is performed.

5. The design method for the fixed-point and floating-point adder according to claim 1, wherein in S3, after the normalization is performed on the floating-point mantissa addition result, the floating-point mantissa addition result is rounded to nearest according to an IEEE-754 standard.

6. The design method for the fixed-point and floating-point adder according to claim 1, wherein in S3, after the normalized result is obtained, floating-point number overflow processing is performed on the normalized result; the floating-point number overflow processing comprises positive overflow processing and negative overflow processing; and a maximum positive normalized number is taken as a positive overflow processing result, and a minimum negative normalized number is taken as a negative overflow processing result.

7. The design method for the fixed-point and floating-point adder according to claim 1, wherein in S3, a parallel logic is adopted between the pre-shift unit and the shared mantissa addition module.

8. The design method for the fixed-point and floating-point adder according to claim 1, wherein operands are included in the mantissas of the floating-point numbers; and when the normalization is performed in S3, the pre-shift unit calculates a number of leading 0/1 according to the operands, and a number of places to be shifted to left during the normalization is determined in advance according to the number of leading 0/1.

9. The design method for the fixed-point and floating-point adder according to claim 1, wherein in S3, when the normalization is performed by the pre-shift unit, the pre-shift unit adopts a carry generation function, a carry propagation function and an annihilation function.
